(19) United States
(12) Patent Application Publication
(10) Pub. No.: US 2015/0248892 A1
(43) Pub. Date: Sep. 3, 2015

(54) METHOD AND APPARATUS FOR DETERMINING AN OPTIMUM FREQUENCY RANGE WITHIN A FULL FREQUENCY RANGE OF A WATERMARKED INPUT SIGNAL

(71) Applicant: THOMSON LICENSING, Issy-les-Moulineaux (FR)

(72) Inventors: Peter Georg Baum, Hannover (DE); Xiaoming Chen, Hannover (DE); Michael Arnold, Isernhagen (DE); Ulrich Gries, Hannover (DE)

(21) Appl. No.: 14/427,655

(22) PCT Filed: Aug. 29, 2013
(86) PCT No.: PCT/EP2013/067925

§ 371 Date: Mar. 12, 2015

(30) Foreign Application Priority Data
Sep. 12, 2012 (EP) 12306098.0

(51) Int. Cl. G10L 19/018; G10L 19/26

(52) U.S. Cl. CPC G10L 19/018; G10L 19/265

(57) ABSTRACT

Many watermarking detection algorithms are correlation based, whereby an input signal is correlated with reference signals. The correlation with the best match determines the bit value of the watermark information. Usually a watermarked signal undergoes distortion before being fed to a watermark detector. However, the modification is stronger in some frequency ranges than in others. According to the invention, the correlation result for a current input signal section is in addition used for estimating the optimal frequency range or ranges for the following section's correlation, using a cumulative correlation value curve.

The invention relates to determining an optimum frequency range within a full frequency range of a watermarked input signal, for carrying out on successive sections of the watermarked input signal a watermark information detection using in each case correlation of one of the sections with reference signals.

### BACKGROUND

Many watermarking detection algorithms are correlation based, whereby an input signal is following some pre-processing correlated with one or more reference signals. The correlation with the best match determines the bit value or values of the watermark information. To be technically feasible, the reference signal has to be band limited. For audio watermarking systems a sampling frequency of 48 kHz is often used, which results in input signals band limited to 24 kHz. In such case a watermarking processing can modify the full frequency range from 0 to 24 kHz, and therefore the reference signals should have the same bandwidth. However, due to computational requirements the bandwidth of the reference signals is often even more reduced.

Usually a watermarked signal undergoes some kind of attack or distortion before being fed to a watermark detector. This attack may be caused by a lossy compression like mp3, or by capturing the input signal with a microphone. Such modifications of the received signal introduce additional noise to the detection process, which in turn reduces the correlation coefficient with the correct reference sequence and therefore decreases the detection strength. If an attack is strong enough for reducing the detection strength below a processing-dependent limit value, the watermarking system will fail in detecting watermark information.

Many attacks on a watermarked signal produce much stronger modification in some frequency ranges than in others. Depending on the kind of attack, different frequency areas of the signal should be used for the correlation in order to improve the detection strength.

A lossy audio codec for example removes high frequencies completely, which also removes the watermark in the upper frequency range while it is still detectable in the lower frequency range. Other codecs like mp3Pro are generating artificial sound in higher frequency ranges which do not carry any watermark information. On the other hand, microphone capture introduces a lot more environmental noise in the lower frequency range than in the upper frequency range. In such cases, where the watermark is completely removed or strongly disturbed in some frequency ranges, these ‘erased areas’ are causing additional noise to the detection and do not contribute positively to the correlation with the correct reference sequence. This means that the signal-to-noise ratio (SNR) in the watermark detector is reduced, which may lead to false or no detections. For example, in case of a watermarking system which embeds watermark information between 0 and 16 kHz and an attack by a low-bitrate lossy codec removing all frequencies above 8 kHz, correlation solely in the frequency range from 0 to 8 kHz leads to better results than the correlation in the full frequency range from 0 to 16 kHz. I.e., for optimal detection the detector has to adapt the correlation frequency range to the kind of attack the watermarked sound has undergone.

### INVENTION

But there are several problems. First, the kind of attack is most often unknown. Second, attacks are often combined, for example a pirated movie sound recorded in a theatre with a microphone, lossy encoded and finally re-encoded for the final pirated movie copy, which makes determining each single attacks very hard. Third, the useful frequency range depends on all details of the attack. In the case of microphone capture, the characteristics of the microphone and the room must be known as well as the exact additional environmental noise. Fourth, the optimal frequency limits may vary over time since the attack may change over time, like additive surrounding noise, or because the watermark detection strength changes over time due to its content dependency. And fifth, using several frequency areas for watermark detection is often not possible due to its very high processing demands, in particular for real-time or mobile applications.

A problem to be solved by the invention is to find the optimum frequency range or ranges to use for the watermark detection. This problem is solved by the method disclosed in claim 1. An apparatus that utilises this method is disclosed in claim 2.

According to the invention, the correlation with a reference signal (e.g. a reference frequency or a reference bit pattern) is calculated initially in a known manner, e.g. by starting with a first estimate of the frequency range, but this correlation result is in addition used for estimating the optimal frequency range or ranges for the following watermark information detection by correlation. The estimate is determined by evaluating a cumulative correlation for the known peak.

Advantageously, the inventive processing requires very little processing power and is therefore useful even in real-time environments on a mobile platform.

In principle, the inventive method is suited for determining an optimum frequency range within a full frequency range of a watermarked input signal, for carrying out on successive sections of said watermarked input signal a watermark information detection using in each case correlation of one of said sections with reference signals, said method including the steps:

a) correlating a current section of said watermarked input signal with several reference signals, using the lower and upper frequency limits of an optimum frequency band used in the watermark information detection of the previous section of said watermarked input signal;

b) selecting the reference signal with the best match and keeping the location of a peak value of the correlation result for said best match;

c) for the selected reference signal, calculating a cumulative correlation value curve in dependence from said location of said correlation value peak;

d) for the following section of said watermarked input signal, determining an optimum frequency band with a lower frequency limit by determining the frequency at which said cumulative correlation value curve starts increasing, and with an upper frequency limit by determining the frequency at which said cumulative correlation curve is no more increasing;

e) continuing with step a).

For a first section of the input signal a frequency band is searched that leads by correlation with several reference signals to watermark information detection, wherein for the second section of the input signal the processing continues with step a).

In principle the inventive apparatus is suited for determining an optimum frequency range within a full frequency range of a watermarked input signal, for carrying out on successive sections of said watermarked input signal a watermark information detection using in each case correlation of one of said sections with reference signals, said apparatus including:
means being adapted for correlating a current section of said watermarked input signal with several reference signals, using the lower and upper frequency limits of an optimum frequency band used in the watermark information detection of the previous section of said watermarked input signal;
means being adapted for selecting the reference signal with the best match and for keeping the location of a peak value of the correlation result for said best match, and for calculating, for the selected reference signal, a cumulative correlation value curve in dependence from said location of said correlation value peak,
and for determining, for the following section of said watermarked input signal, an optimum frequency band with a lower frequency limit by determining the frequency at which said cumulative correlation value curve starts increasing, and with an upper frequency limit by determining the frequency at which said cumulative correlation curve is no more increasing,
and for continuing the processing in said means being adapted for correlating a current section of said watermarked input signal with several reference signals.

For a first section of the input signal a frequency band is searched that leads by correlation with several reference signals to watermark information detection, wherein for the second section of the input signal the processing continues in the means being adapted for correlating a current section of the watermarked input signal with several reference signals.

Advantageous additional embodiments of the invention are disclosed in the respective dependent claims.

### DRAWINGS

Exemplary embodiments of the invention are described with reference to the accompanying drawings, which show in:

FIG. 1 Cumulative correlation values directly after watermark embedding up to 10 kHz without attack;

FIG. 2 Cumulative correlation values for a non-marked sequence;

FIG. 3 Cumulative correlation values for mp3 compression;

FIG. 4 Cumulative correlation values for additive low frequency noise;

FIG. 5 Cumulative correlation values of a watermarked signal with ‘erased’ watermark in several frequency ranges.

FIG. 6 Block diagram for the inventive processing.

### EXEMPLARY EMBODIMENTS

In the above section it is explained why in a watermark detector adaptive selection of frequency limits (i.e. adaptive filtering) for the correlation is necessary in order to optimise the watermark information detection results.

One solution for achieving this is by processing in a brute-force manner, i.e. by testing several frequency limits to see which frequency limits are providing best results. For a watermark system, which embeds watermark information for example between 0 and 16 kHz, having a pre-defined maximum lower limit of 4 kHz, a pre-defined minimum high limit of 8 kHz, and a frequency step width of 500 Hz, this results in 9 lower limits (0 Hz, 500 Hz, 1 kHz, . . . , 4 kHz) and 17 upper limits (8 kHz, 8.5 kHz, 9 kHz, . . . , 16 kHz) to be tested. Which means that, even with a rather coarse resolution of 500 Hz, all together 9+17=26 frequency ranges are to be tested for determining the best watermark detection frequency range, assuming that lower and upper limits can be independently tested. Since each test consists of one or more correlations this is most often not feasible due to time or CPU power constraints.

According to the invention a method for finding optimal frequency limits is described, whose algorithmic complexity is less than one single correlation.

The cross correlation r(τ) of real-valued signals x(t) and y(t) is defined as

r_{xy}(τ)=∫_{-∞}^{∞}x(τ)y(t+τ)dτ (1)

With the Fourier transform F

$$\begin{matrix}F ( x ( t ) ) = X ( ω ) \\ = {\int }_{- ∞}^{∞} x ( t ) {e}^{- jω t} d t ( 3 )\end{matrix} \qquad ( 2 )$$

and its inverse F−1

$$\begin{matrix}{F}^{- 1} ( X ( ω ) ) = {\int }_{- ∞}^{∞} X ( ω ) {e}^{- jω t} d ω \\ = x ( t ) ( 5 )\end{matrix} \qquad ( 4 )$$

this can be written according to the convolutional theorem as

r_{xy}(τ)=F⁻¹(X(ω)Y*(ω)). (6)

The correlation value at a certain time lag τₘ can thus be determined by

r_{xy}(τₘ)=∫_{-∞}^{∞}X(ω)Y*(ω)e^{jωτ}^{ₘ}dω. (7)

This is relevant for a watermarking system because the watermark detector calculates the cross-correlation of the (possibly pre-processed) input signal and all reference sequences. The reference sequence with the best match determines the value of the watermark. The best match can for example be the correlation with the largest correlation result peak. If the position of the peak is known, its correlation value can be calculated with equation (7). The cumulative correlation values c_{c,y,τ}_{ₘ}(φ) are defined as

c_{c,y,τ}_{ₘ}(φ)=∫_{-∞}^{φ}X(ω)Y*(ω)e^{jωτ}^{ₘ}dω, (8)

which describes the accumulation of the peak value over frequency.

This equation represents an effective way of calculating the following processing: in each case the correlation value for a bandpass filtered input signal with increasing bandwidth up to the full bandwidth is summed up, e.g. 1 khz bandwidth, 2 khz bandwidth, 3 khz bandwidth, and so on.

The accumulated peak value will increase substantially if watermark information is detected in a certain frequency range, and it will remain nearly constant if this signal does not contain any watermark information.

Several examples will explain the value or shape of the cumulative correlation function.

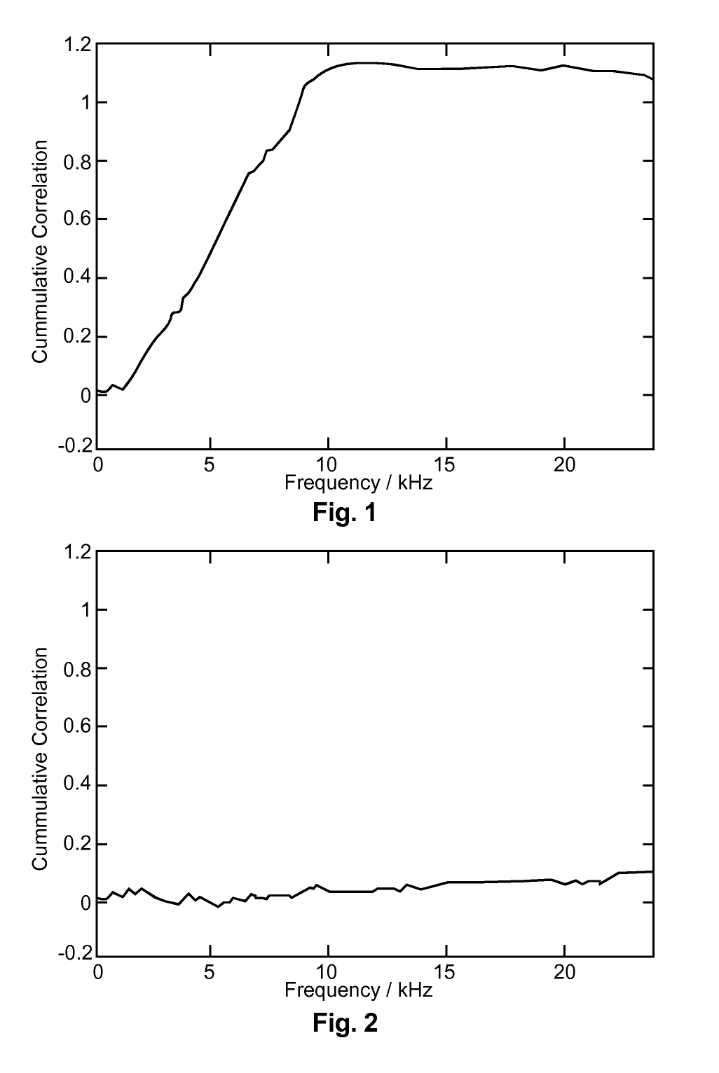

FIG. 1 shows the cumulative correlation value curve vs. frequency for an audio signal block or section which has been watermarked between 300 Hz and 10 kHz. Since no attack has been applied, all frequencies up to 10 kHz are positively contributing to the peak. The addition of the values between 10 kHz and 24 kHz add just noise and even decreases a bit the peak value.

FIG. 2 shows the cumulative correlation value curve for a non-marked sequence. In theory, with a watermark signal that is orthogonal to the carrier signal and with infinite correlation length, the cumulative correlation value curve would be zero. In practice, the curve fluctuates around zero.

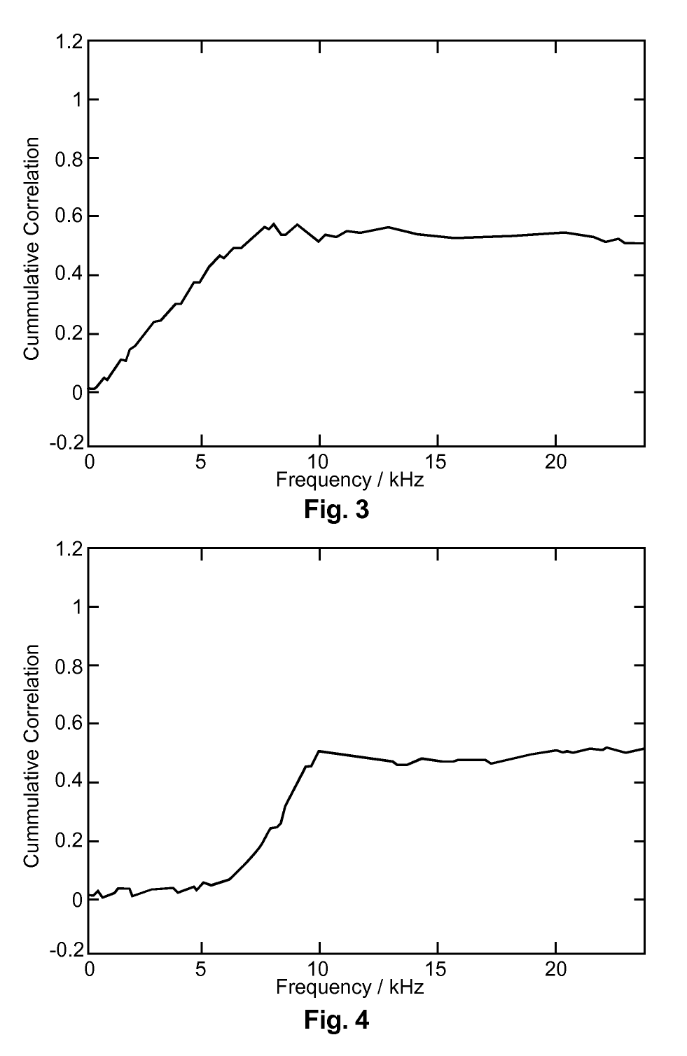

FIG. 3 shows the cumulative correlation value curve for an mp3 compressed audio signal. It can easily be seen that the frequencies up to about 8 kHz are contributing positively to the peak, whereas all frequencies above do nearly not change the peak value.

FIG. 4 shows the cumulative correlation value curve for additive low frequency noise in the input signal. Only the frequency range between about 5 kHz and 10 kHz is contributing positively to the peak value.

The inventive processing uses the location of an existing correlation value peak for determining the optimal frequency limits for the watermark information detection. In each case, the watermark information detection for a current input signal block or section uses the optimal frequency limits of the watermark information detection for a previous input signal block or section. In the watermark information detection for the following input signal block or section the frequency limits are adapted if necessary (and used for the succeeding block), and so on. This kind of processing works even with temporally varying frequency limits since such variations are usually small between adjacent watermark information detections.

One first peak is needed for calculating the very first frequency limits. This is not a problem because in many cases correlation results are good for some input signal blocks or sections and bad for others, depending on the input signal content and the kind of attack. That means, a first optimal filter or frequency limit for a block can be found that leads to good watermark information detection. Otherwise one could start with a first brute-force coarse estimate of the frequency limits and then use the processing described above.

The processing according to the invention for determining the frequency range to be used for the correlation is therefore as follows:
a) Calculate a correlation for a current section of the possibly watermarked input signal with several reference sequences, using the frequency band between the lower and upper frequency limits used in the previous watermark information detection.
b) Select the reference sequence with the best match, and keep the location τₘ of the correlation result peak for that best match.
c) For the selected reference sequence, calculate the cumulative correlation value curve in dependence from the location τₘ of the correlation value peak.
d) For the following section of the watermarked input signal, determine an optimum frequency band with a lower frequency limit by determining the frequency at which the cumulative correlation value curve starts increasing, and with an upper frequency limit by determining the frequency at which the cumulative correlation curve is no more increasing.
e) continue with step a).

In the watermark decoder block diagram in FIG. 6, a received watermarked signal RWAS is re-sampled in a receiving section step or unit RSU, and thereafter may pass through a pre-processing step or stage PRPR wherein frequency band restriction is carried out, and spectral shaping and/or whitening may be carried out. In the following correlation step or stage CORR it is correlated section by section with one or more reference patterns REFP. A decision step or stage DC determines, according to the inventive processing described above, whether or not a correlation result peak is present and the corresponding watermark symbol, calculates for the selected reference sequence the cumulative correlation value curve in dependence from the location τₘ of the correlation value peak, and finally outputs the corresponding watermark information bits INFB. In an optional downstream error correction step or stage ERRC the preliminarily determined watermark information bits INFB of such symbols can be error corrected, resulting in corrected watermark information bits CINFB.

In one embodiment, the calculation of the cumulative correlation value function re-uses a Fourier transformation and/or the multiplication result calculated in step a). In a further embodiment, instead of the (positive) peak correlation value, the largest value of the absolute values of the correlation result is used. In this case the value of the peak may be negative and in step d) the frequency is determined at which the curve starts or ends, respectively, decreasing.

The described processing works in the same manner if a metric more complicated than the size of the largest peak value is used, as long as the metric is some sum or integral over the frequency. In that case the cumulative correlation value of equation (8) is replaced by the cumulative respective function.

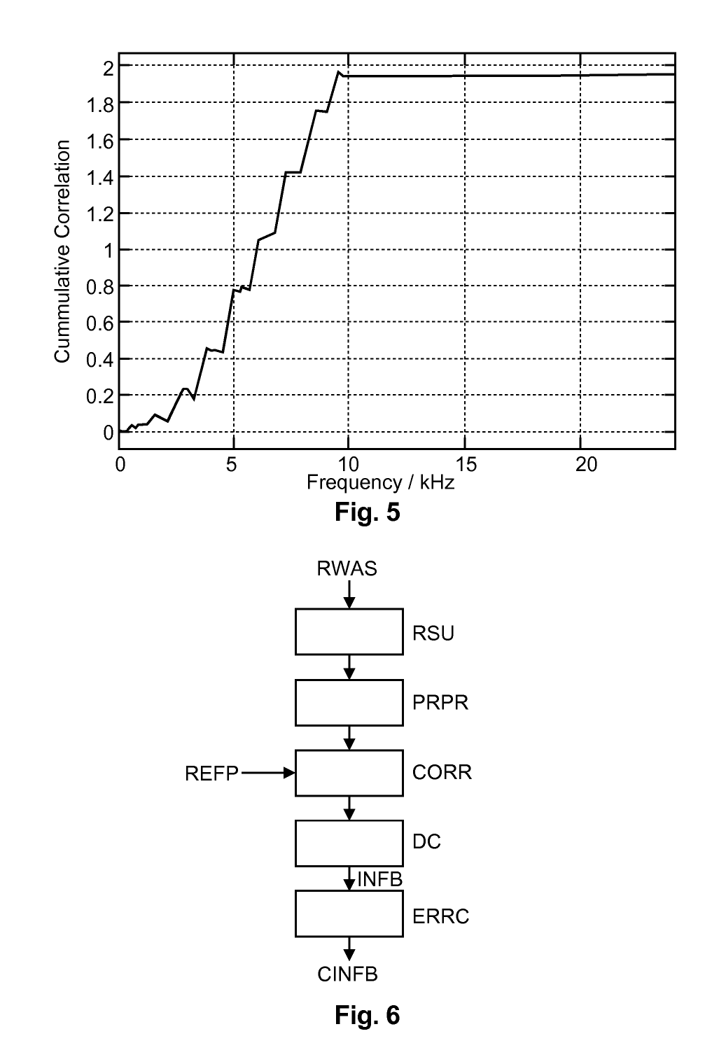

The described processing can not only be used for determining the optimal low and high frequency limits, but also for detection of frequency ranges in between which do not contribute positively to the cumulative correlation value peak. FIG. 5 shows one example where the signal contains watermark information between approximately 0 Hz and 10 kHz, but with seven frequency areas in between where no watermark information is detectable and the cumulative correlation value is nearly constant.

In such case, not only one lower and one upper frequency limit are determined but several lower/upper frequency limit pairs distributed within the total frequency range.

1-6. (canceled)

7. A method for determining an optimum frequency range within a full frequency range of a watermarked audio input signal, for carrying out on successive sections of said watermarked audio input signal a watermark information detection using in each case correlation of one of said sections with reference signals, said method including the steps:
a) correlating a current section of said watermarked audio input signal with several reference signals, using the lower and upper frequency limits of an optimum frequency band used in the watermark information detection of the previous section of said watermarked audio input signal;
b) selecting the reference signal with the best match and keeping the location of a peak value of the correlation result for said best match;
c) for the selected reference signal, calculating a cumulative correlation value curve in dependence from said location of said correlation value peak, wherein for calculating said cumulative correlation value curve correlation result peak values are accumulated over frequency;
d) for the following section of said watermarked audio input signal, determining an optimum frequency band with a lower frequency limit by determining the frequency at which said cumulative correlation value curve starts increasing, and with an upper frequency limit by determining the frequency at which said cumulative correlation curve is no more increasing;
e) continuing with step a).

8. The method according to claim 7, wherein for a first section of said audio input signal a frequency band is searched that leads by correlation with several reference signals to watermark information detection, and wherein for the second section of said audio input signal the processing continues with step a).

9. The method according to claim 7, wherein said calculation of the cumulative correlation value function re-uses a Fourier transformation and/or the multiplication result calculated in step a).

10. The method according to claim 7 wherein, instead of a positive peak correlation value, the largest value of the absolute values of the correlation result is used, and if that largest value is negative, and in step d) the frequency is determined at which the said cumulative correlation value curve starts or ends, respectively, decreasing.

11. The method according to claim 7, wherein not only one lower and one upper frequency limit are determined but several lower/upper frequency limit pairs distributed within the total frequency range.

12. An apparatus for determining an optimum frequency range within a full frequency range of a watermarked audio input signal, for carrying out on successive sections of said watermarked audio input signal a watermark information detection using in each case correlation of one of said sections with reference signals, said apparatus including:
a correlator which correlates a current section of said watermarked audio input signal with several reference signals, using the lower and upper frequency limits of an optimum frequency band used in the watermark information detection of the previous section of said watermarked audio input signal;
a selector which selects the reference signal with the best match and keeps the location of a peak value of the correlation result for said best match,
and which calculates, for the selected reference signal, a cumulative correlation value curve in dependence from said location of said correlation value peak, wherein for calculating said cumulative correlation value curve correlation result peak values are accumulated over frequency,
and which determines, for the following section of said watermarked audio input signal, an optimum frequency band with a lower frequency limit by determining the frequency at which said cumulative correlation value curve starts increasing, and with an upper frequency limit by determining the frequency at which said cumulative correlation curve is no more increasing,
and which continues the processing in said correlator by correlating the current section of said watermarked audio input signal with several reference signals.

13. The apparatus according to claim 12, wherein for a first section of said audio input signal a frequency band is searched that leads by correlation with several reference signals to watermark information detection, and wherein for the second section of said audio input signal the processing continues in said means being adapted for correlating a current section of said watermarked audio input signal with several reference signals.

14. The apparatus according to claim 12, wherein said calculation of the cumulative correlation value function re-uses a Fourier transformation and/or the multiplication result calculated in step a).

15. The apparatus according to claim 12 wherein, instead of a positive peak correlation value, the largest value of the absolute values of the correlation result is used, and if that largest value is negative, and in step d) the frequency is determined at which the said cumulative correlation value curve starts or ends, respectively, decreasing.

16. The apparatus according to claim 12, wherein not only one lower and one upper frequency limit are determined but several lower/upper frequency limit pairs distributed within the total frequency range.
